(19) United States
(12) Patent Application Publication
(10) Pub. No.: US 2009/0123770 A1
(43) Pub. Date: May 14, 2009

(54) Rubber and Plastic Compsite Material Having Reinforcing Layer

(75) Inventor: Keith Gary Melville, Meridian, ID (US)

Correspondence Address: GILBRETH & ASSOCIATES, P.C., PO BOX 2428, BELLAIRE, TX, 77402-2428, US

(73) Assignee: RUMBER MATERIALS INC.

(21) Appl. No.: 11/938,822

(22) Filed: Nov. 13, 2007

(51) Int. Cl. B32B 25/10

(52) U.S. Cl. 428/492; 156/185

(57) ABSTRACT

A composite product comprising a base substrate member, reinforced by an outer reinforcing member. A non-limiting example of this composite product includes recycled tire rubber and thermoplastic base member, around which is wrapped a composite fabric reinforcing member.

### RELATED APPLICATION DATA

None.

### BACKGROUND OF THE INVENTION

1. Field of the Invention

The present invention relates to composite materials and products, and to methods of making and using the same. In another aspect, the present invention relates to rubber and plastic composite materials and products, and to methods of making and using the same. In even another aspect, the present invention relates to rubber and plastic composite materials and products having a reinforcing layer, and to methods of making an using the same. In still another aspect, the present invention relates to rubber and plastic composite materials and products having a reinforcing layer that may be a wrapping or coating, and to methods of making an using the same.

2. Brief Description of the Related Art

Composite materials of rubber and plastic are well known in the art. A number of patents are directed to composite materials made of tire rubber and thermoplastic.

U.S. Pat. No. 5,312,573, issued May 17, 1994, to Rosenbaum, et al., discloses a process for extruding mixtures of thermoplastic and thermoset materials. The patent discloses a method of producing useful articles from ground whole tire waste, which includes the steps of continuously extruding a heated mixture of ground whole tire waste and thermoplastic binder material into a continuously cooled, open-ended casting chamber.

U.S. Pat. No. 5,523,328, issued Jun. 4, 1996, to Rosenbaum, et al., discloses a process and apparatus for extruding mixtures of thermoplastic and thermoset materials and products made therefrom. The patent discloses a method of producing useful articles from ground whole tire waste, which includes the steps of continuously extruding a heated mixture of ground whole tire waste and thermoplastic binder material into a continuously cooled, open-ended casting chamber. The apparatus for practicing this embodiment includes an extruder, a transition nozzle having an outlet with a cross-section corresponding to the desired cross-section of the useful article, and a casting chamber being constructed and arranged to remove thermal energy from an inner surface of the casting chamber.

U.S. Pat. No. 5,861,117, issued Jan. 19, 1999, to Rosenbaum, discloses a process and apparatus for cooling an extrudate. The patent discloses a process for extruding a mixture of thermoplastic and ground whole tire waste, in which the mixture is extruded through a die to form an extrudate, with the extrudate subsequently cooled by directing a cooling gas toward the extrudate top, bottom and sides from a multiplicity of gas jets positioned around the periphery of the extrudate. In addition to an extruder, the apparatus includes a multiplicity of gas jets adjacent the extruder, positioned to direct a cooling gas toward the extrudate top, bottom and sides.

A number of patents directed to reinforcing as follows.

U.S. Pat. No. 5,043,033, issued Aug. 27, 1991, to Fyfe, discloses a Process of improving the strength of existing concrete support columns. In a concrete column supporting an overhead load and having a base end resting on a surface, a process of strengthening the column to increase its ability to withstand atypical physical loading accompanying an earthquake, involving the steps of defining a work area about the surface of the column to which the strengthening is to be applied, the work area defined by circumferential marginal edges arranged in spaced-apart relation; overwrapping the work area with at least one layer of high-strength, stretchable fibers wherein the fibers are oriented at an angle to the vertical axis of the column; applying a coat of hardenable material, having a modulus at least as great as that of the fibers, over the layer of fibers to form a hard outer shell thereover; and, injecting a quantity of a hardenable, low-shrink liquid under the layer of fibers and over the surface of the work area in an amount sufficient to cause the fibers to undergo stretching from about ½% to about 4% of their elongation.

U.S. Pat. No. 5,597,240, issued Jan. 28, 1997, to Fyfe, discloses a structural bearing. A structural bearing including a first, rigid-support member for mounting on a structure on which the bearing is supported; a layer of first elastomeric material mounted on top of the first support member; a second, rigid-support member for operative engagement with a structure supported by the bearing mounted on top of the layer of elastomeric material; a pin rigidly attached to one of the support members and extending through the layer of first elastomeric material; a ring, extending from the rigid-support member to which the pin is not attached, to surround the pin and remain spaced-apart therefrom and extending at least partially about the free end thereof to form a cavity thereabout; and, a ring-shaped layer of second elastomeric material interposed the ring and the pin and in contact with the layer of first elastomeric material for sharing the components of the vertical, horizontal, rotational and torsional loads on the bearing.

U.S. Pat. No. 5,649,398, issued Jul. 22, 1997, to Isley, Jr., et al. discloses high strength fabric reinforced walls. A method is provided for reinforcing the face or faces of walls so as to prevent or reduce the likelihood of failure when such walls are subjected to atypical loadings such as are encountered during earthquakes. The method includes the step of applying a resin-impregnated fabric layer over a portion of an exposed face of a wall to be reinforced. The method includes the further step of anchoring the resin-impregnated fabric layer to a structural member of the wall using fabric fasteners, adhesives, or a combination thereof.

U.S. Pat. No. 5,657,595, issued Aug. 19, 1997, to Fyfe, et al. discloses fabric reinforced beam and column connections. A technique for applying high strength fiber fabric to strengthen beams and the connection between beams and either supported platforms or supporting vertical columns is disclosed. Fabric made of high strength fibers such as glass, boron, or carbon, is laid over the connection between a beam and a platform, or between a beam and a supporting column, and impregnated with an epoxy resin or other polymer matrix. The fabric may be additionally fastened to the structural member using adhesives, fabric fasteners, or bolts. The invention is particularly well suited for retrofitting bridges, freeway overpasses, parking structures, and the like to prevent failure during an earthquake.

U.S. Pat. No. 5,931,198, issued Aug. 3, 1999, to Raji, et al. discloses fabric reinforced pipe. Reinforcement of buried or inaccessible existing pipes is achieved by applying a reinforcement layer which includes a fabric portion. A pipe system structure is achieved which permits an internal or external surface of an existing pipe wall to be reinforced without removing a section of the pipe and without requiring the pipe to be out of service of a long period of time. The reinforcement layer overlays a portion of the internal or the external surface of the pipe. An adhesive material is then applied to the surface of the pipe or to the reinforcement layer for bonding the reinforcement layer to the surface of the pipe to develop a composite system between the existing pipe and the reinforcement layer.

U.S. Pat. No. 6,806,212, issued Oct. 19, 2004, to Fyfe, discloses a coating and method for strengthening a structure. Composite coating (10) improves the resistance to blast or seismic forces of a structure (100), such as wall (101). Coating (10) includes a first layer (20) of elastomeric polyurethane in contact with and adhering to wall (101), a second layer (30) of elastomeric polyurethane in contact with and adhering to first layer (20), and a layer of textile (40) embedded between first layer (20) and second layer (30).

U.S. Pat. No. 7,207,149, issued Apr. 24, 2007, To Fyfe, et al. discloses an anchor and method for reinforcing a structure. Anchor 10 for reinforcing a structure against displacement forces and a method of installation includes drilling a borehole 50 in an anchor medium 110 adjacent the structure. A length of roving 21 composed of filaments 24 is doubled and pushed into borehole 50 with free end 23 of roving 21 protruding. Backfill grout 41 or resin 42 is pumped or poured into bore hole 50 to embed roving 21 filaments 24 of free end 23 are spread apart and attached to the structure by adhesive.

For some uses, there is a need for stronger rubber and plastic composite materials.

### SUMMARY OF THE INVENTION

This disclosure may provide for reinforced rubber and plastic composite materials, products made therefrom, and methods of making and using such materials and products.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a side view of one non-limiting embodiment of composite structure 100 of present invention, which generally comprises a base member 10 comprising a composite substrate member, and a reinforcing member 12.

FIG. 2 is a side view of another non-limiting embodiment of composite structure 100 of present invention, with reinforcing member 12 adhered to the bottom (or top depending upon orientation) and sides of base member 10.

FIG. 3 is a side view of another non-limiting embodiment of composite structure 100 of present invention, with reinforcing member 12 adhered to the top, bottom, and both sides of base member 10.

FIG. 4 is a side view of another non-limiting embodiment of composite structure 100 of present invention, with reinforcing member 12 spirally adhered to the top, bottom, and both sides of base member 10, and even starting to overlap itself.

FIG. 5 is a side view of another non-limiting embodiment of composite structure 100 of present invention, with first reinforcing member 12A adhered to the bottom (or top depending upon orientation), with second reinforcing member 12B wrapped over reinforcing member 12A and around base member 10.

FIG. 6 is a side view of another non-limiting embodiment of composite structure 100 of present invention, with first a multiplicity of members 12 adhered to the bottom (or top depending upon orientation), which members 12 may be the same or different.

### DETAILED DESCRIPTION OF THE INVENTION

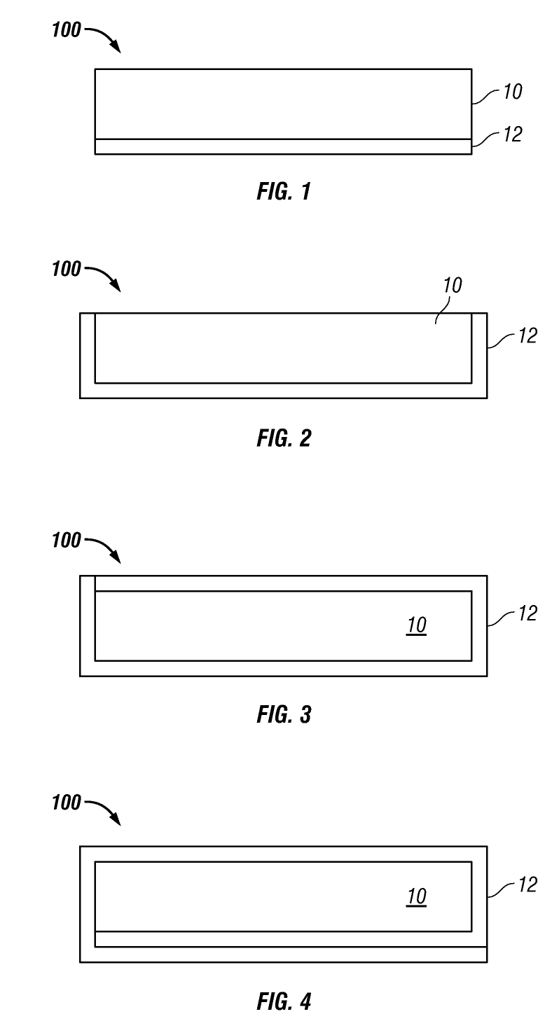

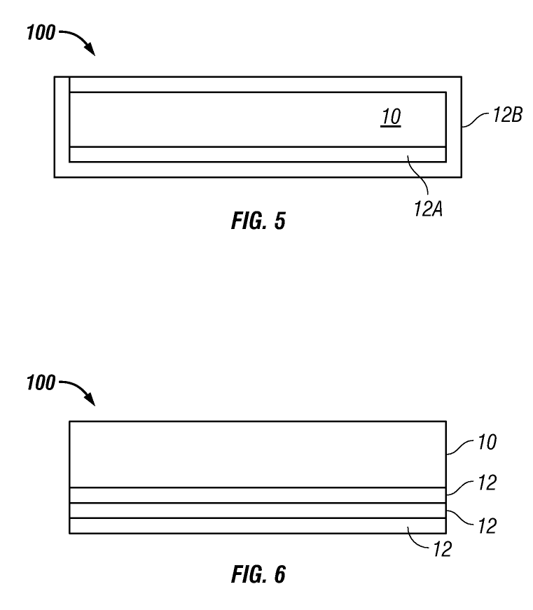

Referring first to FIG. 1, there is shown one embodiment of composite structure 100 of present invention, which generally comprises a base member 10 comprising a composite substrate member, and a reinforcing member 12. It should be understood that while composite structure 10 is illustrated as being rectangular in shape, it may be any shape as desired, non-limiting examples of which include any regular or irregular geometric shape. Reinforcing member 12 may likewise be any desired shape and will generally be shaped to suitably reinforce composite structure 10.

The composite substrate member 10 may generally comprise any suitable combination of thermoplastic and thermoset materials.

Thermoplastic materials useful in the composite substrate material may include any thermoplastic that when processed according to the present invention will yield a product having the desired properties. Mixtures of thermoplastics may be used. Generally, the thermoplastics utilized in the composite substrate material includes at least one selected from the group consisting of polyolefins, polyvinyl chloride, nylons, fluorocarbons, polyurethane prepolymer, polystyrene, high impact strength polystyrene, cellulosic resins, acrylic resins, polyphenylene oxide and polyphenylene sulfide. Preferably, the thermoplastic utilized in the composite substrate material includes at least one selected from the group consisting of polyolefins, and high impact strength polystyrenes. “Polyolefins” refers to polymers derived from simple olefins. The polyolefins may be homopolymers of C2-C20 alpha-olefins and may also be copolymerized with at least one selected from C2-C20 alpha-olefins and C3-C20 polyenes. Preferable polyolefins include ethylene and propylene which refer not only to the homopolymer, but also to polymers having 2 or more monomers in which at least one of the monomers is ethylene br propylene. Most preferably, the thermoplastic utilized in the composite substrate material includes at least one selected from the group consisting of polyethylene, polypropylene, and high impact strength polystyrenes.

Thermoset materials useful in the composite substrate material include any thermoset that when processed according to the present invention will yield a product having the desired properties. Mixtures of thermosets may be used. Generally, the thermoset utilized in the composite substrate material includes at least one selected from the group consisting of rubber, phenolics, alkyds, amino resins, polyesters, epoxides and silicones. Preferably, the thermoset utilized in the present invention is rubber.

“Rubber” as used herein is intended to mean one or more of the following: natural rubber, polymers, interpolymers and copolymers of conjugated diolefins, i.e., polybutadiene, butadiene-styrene copolymers, butadiene-acryionitrile copolymers, polymers and copolymers of methylpentadiene; polymeric forms of chlorine substitution products of conjugated diolefins, i.e., polychioroprene; polymers of non-conjugated systems, i.e., polyisobutylene and copolymers of isobutylene and isoprene; and condensation polymers of the polysulphide type.

The thermosets utilized in the composite substrate material may be obtained from any source, including being produced insitu in the process. However, it is generally commercially desirable that the thermosets utilized in the composite substrate material be obtained as scrap or waste material.

When rubber is utilized as the thermoset material, it is generally desirable that scrap or waste rubber from tires be utilized. In the composite substrate material it is not critical that high grade rubber be utilized. Furthermore, in the composite substrate material, it is not critical that metal or fibers in the tire be removed. Rather, as one novel featurey, the process of the present invention is capable of processing whole tire into a useful article. Generally, tires that may be processed in the present invention include truck, aircraft, heavy machinery, motorcycle, bicycle and automobile tires. Preferably, automobile tires are utilized in the process of the present invention. Tires typically comprise about 50-70 percent rubber, 20-30 percent steel and 5-10 Percent textile fibers.

As a non-limiting example, the composite substrate member may comprise rubber as the thermoset material and any suitable thermoplastic material. As another non-limiting example, the composite substrate may comprise tire rubber as the thermoset material and any suitable thermoplastic material. As even another non-limiting example, the composite substrate may comprise recycled tire rubber as the thermoset material and any suitable thermoplastic material. Non-limiting examples of thermoplastic and thermoset materials and products may be found in U.S. Pat. Nos. 5,312,573, 5,523,328, and 5,861,117, discussed above, and herein incorporated by reference. Additional non-limiting examples may be found in U.S. Pat. Nos. 4,028,288 and 4,003,408, both to Turner, both disclosing products made from recycled tires, and both herein incorporated by reference.

The composite substrate member of the present invention, may include any additives as are generally known to those of skill in the art. Such additives include processing aids, lubricants, colorants, reinforcing fibers, stabilizers, antioxidants, fillers, conductive additives, heat stabilizers, blowing agents and plasticizers. Such additives, if utilized, will generally comprise in the range of about 0.1 to about 25 weight percent of the composite substrate member.

The composite substrate member comprising any suitable combination of thermoplastic and thermoset materials, may be produced by any suitable method. Generally, the thermoplastic material will be at least softened, and most likely melted, with the thermoset materials incorporated therein. This mixture is subjected to molding, extrusion, pultrusion, or any other suitable forming method.

A non-limiting example of a commercially available material suitable for use as the composite substrate material includes RUMBER™ materials available from Rumber Materials, Inc., made from recycled tire rubber and plastics.

The reinforcing member 12 may comprise a woven or non-woven composite fabric.

Composite fabrics made from fibrous materials formed into both woven, knitted and non-woven material, are well-known in the art. Certainly, any suitable material may be utilized, but commonly, yarns of glass, carbon and graphite are typically formed into fabrics, and a plurality of layers of fabric are stacked and cut into dry fabric preforms. These preforms are then stitched and/or impregnated with a resin binder to form a composite fabric.

The composite fabric useful in the present invention, may be constructed of woven, knitted or non-woven fibers, yarns, threads, filaments and the like. The structural fibrous materials may be any well-known materials which form fibers, filaments, threads, yarns, woven fabrics, knitted fabrics, non-woven fabrics, batts, felts, and the like. As used herein, the term, structural fibrous material, embraces all of the various types of materials, which form such fabrics useful to form a composite fabric in accordance with the present invention. Exemplary structural fibrous materials include glass in the form of glass fibers, carbon or graphite in the form of carbon or graphite fibers, non-graphite carbon fibers, vitreous carbon fibers, boron monolithic graphite and monolithic non-graphite carbon fibers, silicon, aramid and other refractory materials. In addition, thermoplastic fibrous material may also be used. The fabric may also be a hybrid fabric, having more than one type of structural fiber in its construction, i.e., glass/thermoplastic, aramid/glass, and other combinations such as combination of the materials listed above.

A non-limiting example of a suitable composite fabric, includes the Tyfo™ Fiberwrap™ Advanced Composite System, manufactured by Fyfe Company LLC. This material is an externally bonded Fiber Reinforced Polymer (FRP) systems, which is known for the strengthening, repair and restoration of masonry, concrete, steel and wooden structures.

These Tyfo™ fiber wrap systems are specialized carbon, glass, aramid and hybrid fabrics combined with resins. These Tyfo™ Advanced Composites are known for use in structural strengthening of masonry, concrete, steel and wooden structures, including seismic retrofit, pipe rehabilitation, blast mitigation, structural preservation, bomb proofing and environmental protection.

More specifically, the Tyfo™ SEH-51A Composite is an ICC-ES ESR-2103 listed material comprised of Tyfo™ S Epoxy and Tyfo™ SEH-51A reinforcing fabric. This Tyfo™ SEH-51A system is a custom weave, uni-directional glass fabric used in the Tyfo™ Fiberwrap System. The glass material is orientated in the 0 degree direction with additional yellow glass cross fibers at 90 degrees. The Tyfo™ S Epoxy is a two-component epoxy matrix material.

The composite structure of present invention may be formed by a number of methods.

The base member and the reinforcing member may be adhered together, generally through use of an adhesive, or by heating of the thermoplastic from the base and/or reinforcing member to allow for adhesion.

As one non-limiting example, an adhesive may be applied to the base member and/or the reinforcing member. The base member and the reinforcing member are then brought together, and kept in contact until the adhesive is cured. Curing may occur at ambient conditions, or may require heat and/or pressure.

Adhesives are well known, and certainly any adhesive suitable for adhering the base and reinforcing member may be utilized. Epoxy adhesives are thought to be useful for adhering many thermoplastics and thermosets.

As another adhesive example, using a two component adhesive system, one component is applied to the base member, with the other component applied to the reinforcing member. Contacting of the base and reinforcing member causes the two component system to cure. This curing may occur at ambient conditions, or may require heat and/or pressure.

As another non-limiting example, a thermoplastic in the base member and/or the reinforcing member will be melted to allow for consolidation between the base member and the reinforcing member.

The present disclosure contemplates embodiments that utilize selective softening/melting of thermoplastics. As a non-limiting example, the thermoplastic materials of the base member and/or the reinforcing member are selected to allow the base thermoplastic material, or the reinforcing thermoplastic material, or both, to soften and/or melt to allow for consolidation. For example, the base member thermoplastics may all soften/melt above 350 F, whereas the reinforcing member thermoplastic may melt at 250 F. Applying heat at 260 F, only the reinforcing member thermoplastic will be melted. Likewise, applying heat at 360 F will allow both to be melted.

The reinforcing member may be applied to any portion of the base member. As a non-limiting example, in FIG. 1, reinforcing member 12 is applied to the bottom (or could be top depending upon orientation) of base member 10. For example, a portion, several portions, or all of the surface area of the base member may be covered with a reinforcing member. Referring additionally to FIG. 2, there is shown a side view of another non-limiting embodiment of composite structure 100 of present invention, with reinforcing member 12 adhered to the bottom (or top depending upon orientation) and sides of base member 10. Certainly, the present invention contemplates having reinforcing member on any one or more of the bottom, top, left or right sides of base member, on any portion of any one or more sides of base member 10.

As one non-limiting example, the reinforcing member may be applied by wrapping one or more continuous reinforcing members onto the base member. Referring additionally to FIG. 3 there is shown a side view of another non-limiting embodiment of composite structure 100 of present invention, with reinforcing member 12 wrapped onto to the top, bottom, and both sides of base member 10. Referring additionally to FIG. 4 there is shown a side view of another non-limiting embodiment of composite structure 100 of present invention, with reinforcing member 12 spirally adhered to the top, bottom, and both sides of base member 10, and even starting to overlap itself.

For some embodiments, the reinforcing member may be utilized to provide reinforcement to the structural strength of the base member. In other embodiments, the reinforcing member may be utilized to provide an environmental barrier. As a non-limiting example, water resistance or chemical resistance.

In even other embodiments, the reinforcing member may be utilized to provide a decorative surface to the base member, which maybe in the form of a certain color, a certain pattern, a certain texture or feel, indentions, and/or protrusions.

In other embodiments, the reinforcing member may be utilized to provide a certain surface texture. For example, for a flooring, it may be desirable to provide a slip resistance surface in the form of a raised pattern, grooves for liquid drainage, and/or surface texture, all of which may be imparted with the proper reinforcing layer.

In still other embodiments, the reinforcing member may be utilized to function as thermal barrier or insulation layer.

In yet other embodiments, the reinforcing member may be utilized to function as a sound barrier or insulation layer.

In still other embodiments, the reinforcing member may be utilized to function as shock resistance or absorption layer.

It should be understood that two or more reinforcing layers may be utilized, which may be the same or different. Referring additionally to FIG. 6 there is shown a side view of another non-limiting embodiment of composite structure 100 of present invention, with first a multiplicity of members 12 adhered to the bottom (or top depending upon orientation), which members 12 may be the same or different.

The products of the present invention comprising a base member substrate and reinforcing member find utility in a wide variety of applications in which the base member might be useful, such as trailer flooring/boards, horse/livestock, livestock handling equipment, implement/utility/skid, tag/contractor equipment, heavy equipment, flatbed, ez runner-snowmobile, sill plates-home foundation, bridge walkway-golf course, trail bumpers, chock block, dunnage boards, side/extension dump boards, frame rail boards, truck beds, rolloffs-tow beds, crane trucks, military-all types of trailers, dunnage boards, military shoot shacks and tank berms, truck beds, chock block, combat offload pallet (cop), boat docks, boat marinas, seawalls/ferry landings/bulkheads/boat ramps/slips, rumber composite, custom molding, racking boards, trailers, matting boards (platform), pipe stripping, blast bunkers, proprietary o.e.m. parts.

### EXAMPLES

The following examples are merely provided to illustrate non-limiting embodiments of the invention, and are not to limit the scope of the claims.

### Example 1

### Point Loading and Deflection Test

Each sample was secured into a mock-up trailer floor beam construction, with beams place at 24″ centers. A base comprising Rumber board and a single E-glass laminate was compared to an apitong board. Apitong is a popular commercial species of a Malaysian hardwood used for truck decking. A point load was applied over the board width, using hydraulic ram, with a dial indicator used to record the amount of deflection at each load increment. The boards were loaded in 100 psi gauge increments: the table below lists the applicable load in lbs. for each psig increment. Both samples had a thickness of 2.375″.

| | Rumber with Single E- | |
|---|---|---|
| | Glass Laminate | Apitong |
| Load (lbs) | Deflection (in.) | Deflection (in.) |
| 930 | 0.150 | 0.013 |
| 1,490 | 0.263 | 0.020 |
| 2,110 | 0.353 | 0.027 |
| 2,710 | 0.475 | 0.035 |
| 3,340 | 0.589 | 0.041 |
| 4,050 | 0.775 | 0.048 |
| 4,660 | 0.996 | 0.055 |
| 5,360 | 1.066 | 0.062 |
| 5,990 | 1.191 | 0.068 |
| 6,720 | 1.326 | 0.076 |
| 7,470 | 1.550 | 0.083 |
| 8,160 | 1.716 | 0.088 |

The Rumber board reinforced with the E-glass laminate compared well to the apitong board. At a load of 8,160 lbs., the laminate began separating from the Rumber board, at which time the load was released. Prior to loading, the clearance from the Rumber board to the base of the loading frame was 19.5″ After releasing the 8,160 lb load, this same clearance measured 18.875″, meaning a permanent set of 0.625″ was observed on the Rumber board with the single E-Glass laminate backing. The Apitong board exhibited no permanent set after releasing the same load.

### Example 2

### Rumber Boards

### Plain vs. Fiberwrap

Identification: 9104 Boards

Description: 1½″×7″ tested on 12″ beam centers

| | |
|---|---|
| Plain Board | Fiberwrap |

| Load (lbs) | Deflection (in.) | Load (lbs) | Deflection (in.) |
|---|---|---|---|
| 840 | 0.095 | 840 | 0.050 |
| 1,510 | 0.290 | 1,510 | 0.076 |
| 2,040 | 0.540 | 2,040 | 0.128 |
| 2,365 | 0.660 | 2,850 | 0.225 |
| — | — | 3,550 | 0.320 |
| — | — | 3,975 | 0.400 |

Loading was stopped at 3,975 lbs. at beginning of separation and cracking of fiberwrap.

All patents, applications, and articles cited herein, are hereby incorporated by reference.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A composite structure comprising:
a base member comprising rubber and polyolefins; and
a reinforcing member supported by base member, and comprising a woven or non-woven composite fabric.

2. The composite structure of claim 1, wherein at least a portion of the rubber is recycled tire rubber.

3. The composite structure of claim 2, wherein at least a portion of the polyolefin is recycled polyolefin.

4. The composite structure of claim 1, the reinforcing member functions to provide at least one of sound insulation, thermal insulation, shock insulation, chemical resistance, decoration, or surface texture.

5. The composite structure of claim 1, wherein the base member comprise Rumber material.

6. The composite structure of claim 1, wherein the reinforcing member comprises two or more layers.

7. The composite structure of claim 1, wherein the reinforcing member is spirally positioned around the base member.

8. The composite structure of claim 1, wherein the base member comprises at least three sides, with the reinforcing member adhered to the three sides.

9. A method of making a composite structure comprising:
assembling a base member and a reinforcing member together so that the reinforcing member is supported by the base member, wherein the base member comprises rubber and polyolefins, and the reinforcing member comprises a woven or non-woven composite fabric.

10. The method of claim 9, wherein at least a portion of the rubber is recycled tire rubber.

11. The method of claim 10, wherein at least a portion of the polyolefin is recycled polyolefin.

12. The method of claim 9, wherein the reinforcing member functions to provide at least one of sound insulation, thermal insulation, shock insulation, chemical resistance, decoration, or surface texture.

13. The method of claim 9, wherein the base member comprises Rumber material.

14. The method of claim 9, wherein the reinforcing member comprises two or more layers.

15. The method of claim 9, wherein assembling comprises winding the reinforcing member around the base member.

16. The method of claim 9, wherein the base member comprises at least three sides, with the reinforcing member adhered to the three sides.
